(19) United States
(12) Patent Application Publication
(10) Pub. No.: US 2007/0029962 A1
(43) Pub. Date: Feb. 8, 2007

(54) Monitoring device and self-propelled cleaner

(75) Inventor: Ryo Saeki, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/497,386

(22) Filed: Aug. 2, 2006

(30) Foreign Application Priority Data
Aug. 2, 2005 (JP) 2005-224368

(51) Int. Cl. G05D 1/00

(52) U.S. Cl. 318/587

(57) ABSTRACT

Disclosed is a monitoring device and a self-propelled cleaner including the monitoring device, that track a moving body securely and stably. Within the monitoring device 9, presence of the moving body is detected by a moving body detecting section according to image data imaged by an imaging device 52 as an imaging section. When it is detected, its position is identified by a moving body position identification section, and an area in which the moving body is positioned is determined by an area determining section, within dividing an imaging region concerning the obtained image data into three areas of area A, area B, area C. The imaging device 52 is rotated so that a center line (one among Ca, Cb, Cc) overlaps with position of the moving body. Here, the center line is orthogonal to horizontal direction of the area, where moving body is positioned.

### BACKGROUND OF THE INVENTION

1. Field of the Invention

The present invention relates to a monitoring device and a self-propelled cleaner.

2. Description of the Related Art

Conventionally, a cleaner that autonomously runs and performs cleaning has been known. In addition, a self-propelled cleaner that is provided with a monitoring device to monitor intrusion of a moving body and the like has been known.

Concerning such monitoring device, a method in which a monitoring camera rotates vertically and horizontally in correspondence to a monitoring object, and thus track the moving monitoring object, has been known for example.

Concerning a monitoring device that tracks a moving body, a type of a monitoring device that tracks so that gravity center of the moving body overlaps the center of imaging region of monitoring camera, when a moving body is detected, has been known.

In addition, a technique to display a stable tracking screen on a monitor is disclosed. In this technique, to each area that are obtained by partitioning the imaging region vertically and horizontally with borderline, an overlapping area with a certain width that overlaps with an area that is vertically and horizontally adjacent is also provided. Even in case where detection area of object body changes, it is not determined that the object body has moved into a next area, so long as it does not pass through the overlapping area. (For example, refer to Japanese Patent Specification (Laid open) No. 2002-27442, hereinafter referred to as patent document 1.)

### SUMMARY OF THE INVENTION

Concerning the type of a monitoring device that tracks so that gravity center of the moving body overlaps the center of imaging region of monitoring camera, the monitoring camera rotates in accordance with the monitoring object when the monitoring object moves. However, in a case where the movement of the monitoring object is fast, or the monitoring object reciprocates within going over monitoring region, the monitoring camera would move vertiginously in accordance with the monitoring object, thus problem arise in that condition of the monitoring region cannot be ascertained by the monitor fully, and that tracking of monitoring object cannot be done in a timely manner.

In addition, even with the technique disclosed in patent document 1, in a case where the object body moves fast within going over boundary of the overlapping area, in a similar manner as above, a circumstance in which tracking by monitoring camera cannot be done in a timely manner, and condition of the monitoring region cannot be ascertained by the monitor fully, may occur.

Therefore, an object of the present invention is to provide a monitoring device that tracks a moving object, which intrudes into a monitoring region, more securely and more stably. It is also an object of the present invention to provide a self-propelled cleaner equipped with such monitoring device.

In order to solve the afore-mentioned problems, a self-propelled cleaner reflecting one aspect of the present invention, which is arranged in a monitoring region is provided with a monitoring device to monitor a moving body that moves in the monitoring region, wherein the monitoring device comprises: an infrared ray irradiating section to irradiate infrared ray to the monitoring region; an imaging section to obtain image data by imaging a reflected light of an infrared ray irradiated from the infrared ray irradiating section; a moving body detecting section to detect a region that has a difference in brightness larger than a predetermined difference in brightness, as the moving body, concerning a difference image of first image data and second image data obtained continuously by the imaging section; a moving body position identification section to identify a gravity center of the moving body as a position of the moving body according to the image data obtained by the imaging section, wherein the moving body is detected by the moving body detecting section; an area determining section to determine an area in which the moving body is positioned, according to the position of the moving body identified by the moving body position identification section, by dividing an imaging region concerning the image data obtained by the imaging section; and a tracking section to conduct tracking of the moving body by moving the imaging section so that a predetermined center region of the area in which it is determined that the moving body is positioned overlaps with the position of the moving body identified by the moving body position identification section.

Since the movement of the imaging section is conducted so that the predetermined center region of the area in which it is determined that the moving body is positioned overlaps with the position of the moving body identified by the moving body position identification section, movement of the imaging section is conducted more minutely compared to the conventional technique. Therefore, problems such as tracking cannot be done in a timely manner, and condition of the monitoring region cannot be ascertained fully, can be decreased even in case where the moving body moves fast in the monitoring region. Thus, monitoring of the moving body can be conducted more securely and more stably.

Further, since the imaging is conducted by irradiating infrared ray to the monitoring region and imaging reflected light of the irradiated infrared ray, monitoring can be conducted even in a case where brightness of the monitoring region is not enough, such as nighttime.

In addition, concerning the difference image of the first image data and the second image data, an area in which difference in brightness larger than a predetermined difference in brightness is measured, is detected as the moving body. In addition, the gravity center of the moving body, which is detected by the moving body detecting section, is identified as the position of the moving body. Therefore, detection and position identification of the moving body are conducted securely.

Further, since the monitoring device is provided to the self-propelled cleaner, performance as self-propelled cleaner or performance as monitoring device can be selected for use as needed.

A monitoring device reflecting another aspect of the present invention, which is arranged in a monitoring region to monitor a moving body that moves in the monitoring region comprises; an imaging section to obtain image data by imaging the monitoring region; a moving body detecting section to detect whether the moving body exists or not, according to the image data obtained by the imaging section; a moving body position identification section to identify a position of the moving body according to the image data obtained by the imaging section, wherein the moving body is detected by the moving body detecting section; an area determining section to determine an area in which the moving body is positioned, according to the position of the moving body identified by the moving body position identification section, by dividing an imaging region concerning the image data obtained by the imaging section; and a tracking section to conduct tracking of the moving body by moving the imaging section so that a predetermined center region of the area in which it is determined that the moving body is positioned overlaps with the position of the moving body identified by the moving body position identification section.

Since the movement of the imaging section is conducted so that the predetermined center region of the area in which it is determined that the moving body is positioned overlaps with the position of the moving body identified by the moving body position identification section, movement of the imaging section is conducted more minutely compared to the conventional technique. Therefore, problems such as tracking cannot be done in a timely manner, and condition of the monitoring region cannot be ascertained fully, can be decreased even in case where the moving body moves fast in the monitoring region. Thus, monitoring of the moving body can be conducted more securely and more stably.

Preferably, the monitoring device further comprises an infrared ray irradiating section to irradiate infrared ray to the monitoring region, wherein the imaging section images a reflected light of an infrared ray irradiated from the infrared ray irradiating section.

Since the imaging is conducted by irradiating infrared ray to the monitoring region and imaging reflected light of the irradiated infrared ray, monitoring can be conducted even in a case where brightness of the monitoring region is not enough, such as nighttime.

Preferably, concerning the monitoring device, the moving body detecting section detects a region in which a difference in brightness larger than a predetermined difference in brightness is measured, as the moving body, concerning a difference image of first image data and second image data imaged continuously by the imaging section; and the moving body position identification section identifies a gravity center of the moving body as a position of the moving body detected by the moving body detecting section.

Further, concerning the difference image of the first image data and the second image data, an area in which difference in brightness larger than a predetermined difference in brightness is measured, is detected as the moving body. In addition, the gravity center of the moving body, which is detected by the moving body detecting section, is identified as the position of the moving body. Therefore, detection and position identification of the moving body are conducted securely.

Preferably, a self-propelled cleaner is provided with the afore-mentioned monitoring device.

Since the monitoring device is provided to the self-propelled cleaner, performance as self-propelled cleaner or performance as monitoring device can be selected for use as needed.

### BREIF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein;

FIG. 1 is a side view of a self-propelled cleaner according to the present invention;

FIG. 2 is a plane view of the self-propelled cleaner according to the present invention;

FIG. 3 is a front view of the self-propelled cleaner according to the present invention;

FIG. 4 is a block diagram showing a principal structure of the self-propelled cleaner according to the present invention;

FIG. 5 is an example of monitoring region seen from above;

FIG. 6 is view showing image data imaged by an imaging device;

FIG. 7 is a flow chart showing a tracking imaging performance processing concerning monitoring mode of the self-propelled cleaner according to the present invention; and

FIG. 8 is a view showing an example of image data of a tracking imaging performance processing after identification of the position of the moving object, of the self-propelled cleaner according to the present invention.

### DETAILED DESCRIPTION OF THE PREFERRED EMBODIMENT

An embodiment of the present invention will be described with reference to figures.

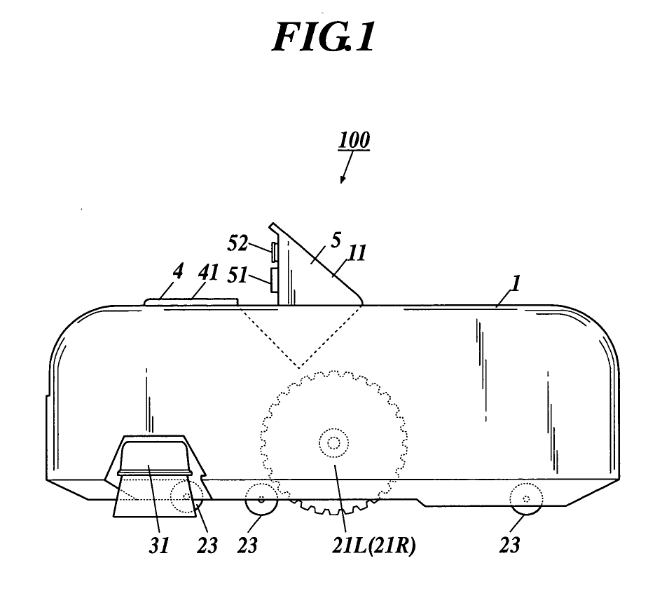

A self-propelled cleaner 100 of the present embodiment is, for example, a cleaner that conducts cleaning by self-propelling in accordance with a predetermined traveling pattern in a room or the like. As shown in FIG. 1 through FIG. 4, the self-propelled cleaner is provided with: a package 1 whose outer shape is a substantially disc shape and its upper side closed, a motor driving unit 2 that is provided inside the package 1 to move or rotate the self-propelled cleaner 100 in a predetermined direction, a cleaning brush driving unit 3 that includes a cleaning brush 31 and the like to clean dust and the like on a cleaning surface which is a traveling surface during movement, an operation input unit 4 that outputs command signal to control unit 6 within operation from a user, an imaging unit 5 to detect presence and direction of a moving body as an intruder and conduct imaging of the moving body, a control unit 6 to conduct operation control of each unit, a rotation angle detecting unit 7 to detect rotation angle of the self-propelled cleaner 100, and a communication unit 8.

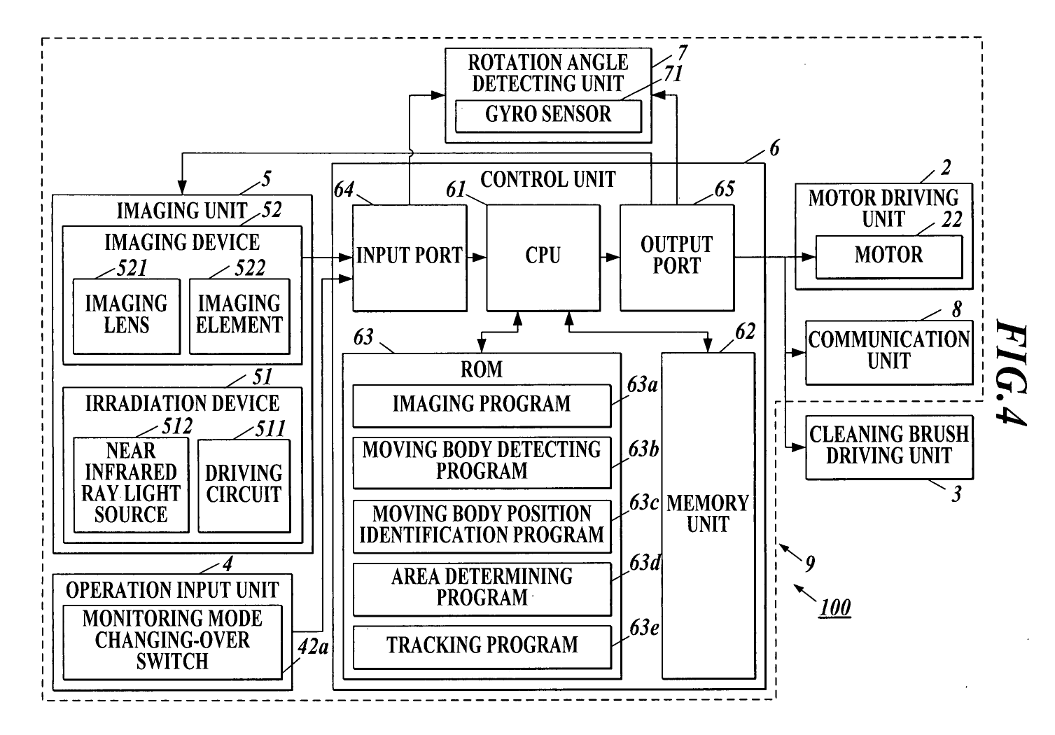

Further, as shown in FIG. 4, a monitoring device 9 provided to the self-propelled cleaner 100 is structured with, for example, motor driving unit 2, operation input unit 4, imaging unit 5, control unit 6, rotation angle detecting unit 7, communication unit 8, and the like.

The package 1 is provided so as to cover the upper side and the horizontal side of the motor driving unit 2, the control unit 6, and the like. Thus, the motor driving unit 2, the control unit 6, and the like are protected from external shock, dust, and the like.

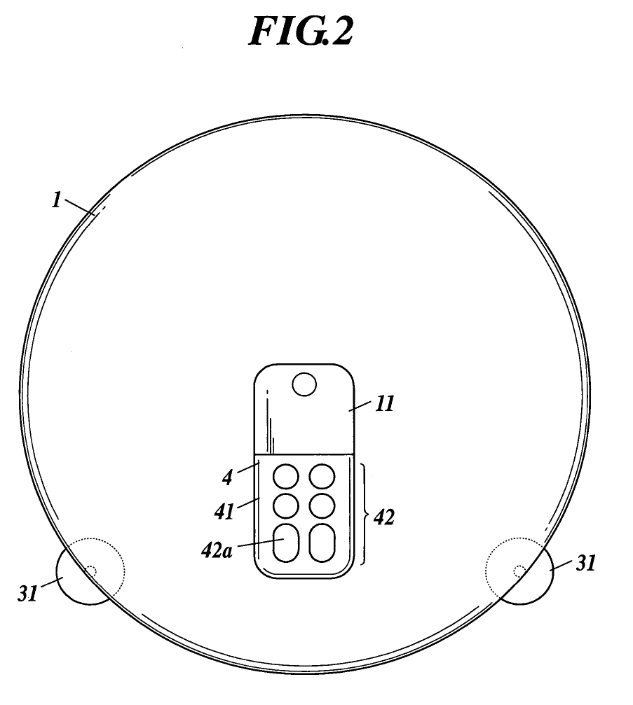

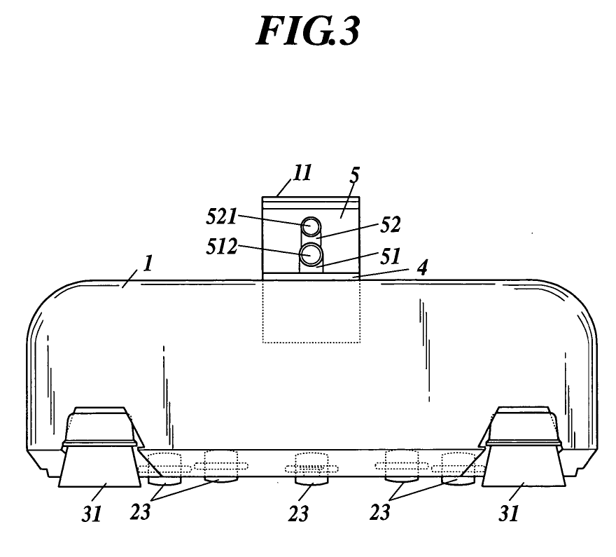

Further, a lid 11 is provided on the upper surface portion of the package 1, and the imaging unit 5 is provided on the lower surface of the lid 11. When the lid 11 is closed, the imaging unit 5 is contained in the package 1 (refer to FIG. 2), and when the lid 11 is opened, the imaging unit 5 is taken out of the package 1 and thus placed on the upper surface portion of the package 1 (refer to FIG. 1 and FIG. 3).

The motor driving unit 2 includes, two driving wheels 21L and 21R that are arranged at left and right end portion, regarding the direction of traveling of the self-propelled cleaner 100, at the bottom and substantial center portion of the self-propelled cleaner 100. The motor driving unit 2 further includes, motor 22 to rotation drive the driving wheels 21L and 21R independently, a predetermined number of driven wheels 23 (five driven wheels 23 are shown in FIG. 3) that rotation drive in a driven manner according to traveling of the self-propelled cleaner, a proximal sensor (not shown) that measures distance to an obstacle.

The operation input unit 4 is provided on the upper surface portion of the package 1. An operation panel 41 of the operation input unit 4 is provided with a plurality of operation keys 42 to instruct execution or the like of various kids of performances of the self-propelled cleaner 100, and outputs a predetermined operation signal that correspond to the operation key 42 operated by a user, to the control unit 6.

Specifically, the operation panel 41 is provided with a monitoring mode changing-over switch 42a to instruct settings of monitoring mode, to conduct monitoring of a moving body by driving motor driving unit 2, imaging unit 5, control unit 6, rotation angle detecting unit 7, and communication unit 8.

The imaging unit 5 is provided with an irradiation device 51 as an infrared ray irradiating section that includes a near infrared ray light source 512 to emit near infrared ray, and an imaging device 52 as an imaging section that image an imaging subject.

The irradiation device 51 is provided with a driving circuit 511 that is connected to the control unit 6, and the near infrared ray light source 512.

The near infrared ray light source 512 is, for example, structured with an infrared ray lamp and the like, and supplies current required to light the near infrared light source 512 to the near infrared ray light source 512, according to a control signal from the control unit 6.

The imaging device 52 is provided with an imaging lens 521 that focus an imaging subject image by converging reflected light, which is a light emitted from the near infrared ray light source 512 and reflected at the imaging subject. The imaging device 52 is also provided with an imaging element 522, which has optical sensitivity in near infrared ray region, and forms image of the imaging subject according to the imaging subject image focused by the imaging lens 521.

The imaging lens 521 is arranged so that it is capable of focusing at acceptance surface of the imaging element 522, and is structured with a convex lens or a concave lens alone, or with a combination of these.

The imaging element 522 is structured with CCD (Charge Coupled Device), CMOS (Complementary Metal Oxide Semiconductor), and the like, and images imaging subject region in front of the imaging lens 521 in accordance with the control from the control unit 6. More specifically, a focused image that is inputted from the imaging lens 521 is converted into an electronic signal by CMOS and the like, image data as a digital signal is generated by A/D converter circuit and the like, and this image data is outputted to the control unit 6.

In addition, an infrared ray transmission filter (not shown) is provided to the imaging unit 5. The infrared ray transmission filter is a filter to block light with wavelength that is referred to as visible light, and transmits only near infrared ray. This is to eliminate light of fluorescent lamp in the room, and improve detection accuracy of the moving object.

The control unit 6 is structured with CPU (Central Processing Unit) 61, memory unit 62, ROM (Read Only Memory) 63, input port 64, output port 65, and the like.

The CPU 61 executes various kinds of programs stored in the ROM 63 in accordance with instruction input and the like from the operation input unit 4, and outputs output signal to each unit, thus conducts integrated control of overall performance of the self-propelled cleaner 100.

The memory unit 62 is structured not only with RAM (Random Access Memory), but also with a nonvolatile memory such as EPROM (Erasable Programmable Rom), flash memory, and the like. The memory unit 62 stores various kinds of programs executed by the CPU 61, input data, and processing result that is generated when program is executed.

The ROM 63 stores various kinds of data processing programs executed by the CPU 61 and data such as various kinds of initial setting values concerning processing of each program.

Specifically, the ROM 63 stores imaging program 63a, moving body detecting program 63b, moving body position identification program 63c, area determining program 63d, tracking program 63e, and the like.

The imaging program 63a is a program that realizes a performance that make the CPU 61 control the driving circuit 511 to light the near infrared ray light source 512 by supplying current, control the imaging device 52 to output image data as a digital signal to the control unit 6. Here, the image data is obtained by converting focused image focused by converging reflected light from the imaging subject, through the imaging lens 521, into an electronic signal.

In addition, the imaging program 63a is a program that realize a performance that make the CPU 61 obtain a plurality of image data imaged by the imaging device 52 continuously with a predetermined time interval.

The moving body detecting program 63b is a program to realize a performance that make the CPU 61 detect intrusion of moving body into monitoring region, by applying a predetermined image processing to the image data obtained by execution of the imaging program 63a.

Specifically, the CPU 61 conducts difference processing concerning first image data imaged by the imaging device 52 and second image data imaged after obtaining the first image data, continuously after a predetermined time interval. Subsequently, concerning a difference image generated by the difference processing, difference in brightness is measured, and it is determined whether a difference in brightness larger than a predetermined standard value (predetermined difference in brightness) is measured or not. In a case where it is determined that a difference in brightness larger than the standard value was measured, the CPU 61 determines that a moving body was detected.

The CPU 61 executes the moving body detecting program 63b so as to perform as a moving body detecting section.

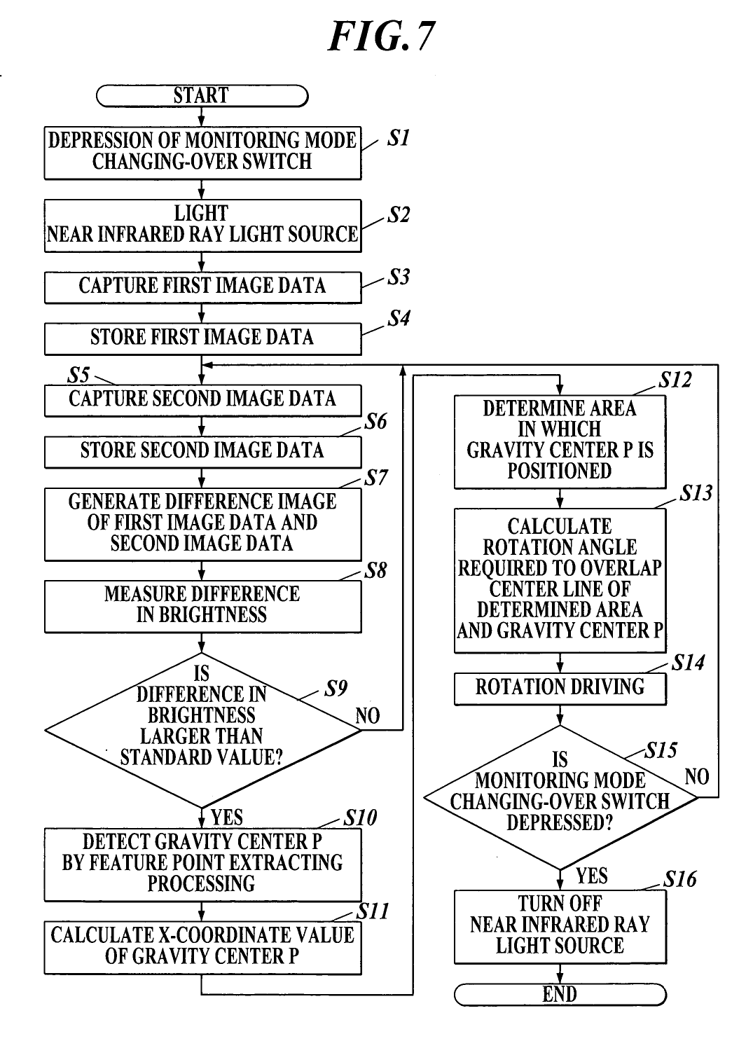

The moving body position identification program 63c is a program that realize a performance, that make the CPU 61 conduct binarization, labeling and the like to the difference image of the first image data and the second image data, then further conduct feature point extracting processing to detect gravity center P of the moving body, and identify the position within the monitoring region, in a case where a moving body is detected by execution of the moving body detecting program 63b. Specifically, the CPU 61, as shown in FIG. 6 for example, sets x-axis in horizontal direction, and sets y-axis in vertical direction concerning the image data imaged by the imaging device with field angle of 60 degrees. Subsequently, position of the moving body is identified in accordance with x-coordinate value of gravity center P of the moving body obtained from the image data, in case the value of x-coordinate at the left end of the x-axis is set to 0, and the value of x-coordinate at the right end of the x-axis is set to 60.

The CPU 61 executes the moving body position identification program 63c so as to perform as a moving body position identification section.

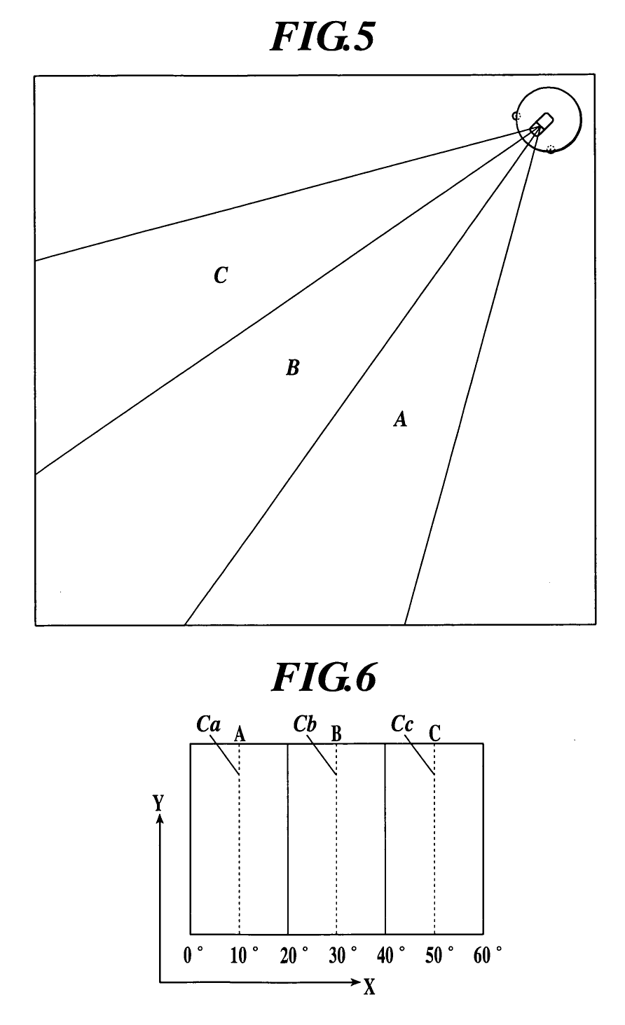

The area determining program 63d is a program that realize a performance that make the CPU 61 conduct division of imaging region concerning the image data into a plurality of areas, and conduct determination on in which area the position of the moving body within the image data exists, wherein the position of the moving body is identified by execution of the moving body position identification program 63c. Specifically, as shown in FIG. 5 and FIG. 6, an imaging area concerning image data obtained by imaging a predetermined monitoring region with the imaging device is, for example, divided into three imaging areas of area A, area B, and area C. That is, the imaging region is divided into area A with x-coordinate value of 0 to 20 degrees, area B with x-coordinate value of 20 to 40 degrees, and area C with x-coordinate value of 40 to 60 degrees. Subsequently, the CPU 61 determines the area in which the gravity center P of the moving body is positioned, in accordance with the x-coordinate value of the center gravity P of the moving body obtained from the image data by executing the area determining program 63d.

The CPU 61 executes the area determining program 63d so as to perform as an area determining section.

The tracking program 63e is a program that realize the performance that makes the CPU 61 conduct tracking with rotating the self-propelled cleaner 100 by driving the motor driving unit 2, so that a predetermined center region of the area in which it is determined that the gravity center P as the position of the moving body is positioned according to the execution of the area determining program 63d, and the gravity center P of the moving body overlap.

Here, the predetermined center region is, for example, on a center line that is parallel to the y-axis and runs through the center of each area. For example, as shown in FIG. 6, center line Ca of the area A is a line that has x-coordinate value of 10 degrees and is parallel to the y-axis, center line Cb of the area B is a line that has x-coordinate value of 30 degrees and is parallel to the y-axis, and center line Cc of the area C is a line that has x-coordinate value of 50 degrees and is parallel to the y-axis. By executing the tracking program 63e, the CPU 61 calculates a rotation angle required to overlap a center line of an area in which it is determined that gravity center P as the position of the moving body is positioned (one among Ca, Cb, or Cc), with the gravity center P of the moving body. Subsequently, the CPU 61 outputs an instruction signal to rotation drive the self-propelled cleaner 100 within an amount of angle calculated, to the motor driving unit 2.

The CPU 61 executes the tracking program 63e so as to perform as tracking section.

The rotation angle detecting unit 7 is structured including a gyro sensor 71 for example. By executing the tracking program 63e, the CPU 61 makes the gyro sensor 71 to measure rotation angle since the time rotation started, when making the self-propelled cleaner 100 rotation drive within an amount of angle calculated by outputting the instruction signal to the motor driving unit 2. Subsequently, in a case where it is determined that the self-propelled cleaner 100 has rotated for the amount calculated, according to the rotation angle measured by the gyro sensor 71, the CPU 61 outputs an instruction signal to stop the rotation drive to the motor driving unit 2.

The communication unit 8 is structured with modem (MODEM: MOdulator/DEModulator), terminal adapter, LAN adapter, and the like, and communicates with external apparatus such as external device (not shown) through a network (not shown). Specifically, the communication unit 8 sends message to an external device (mobile phone of a householder, terminal device of a security firm, and the like for example) in accordance with control from the control unit 6, in a case where the moving body is detected by execution of the moving body detecting program 63b.

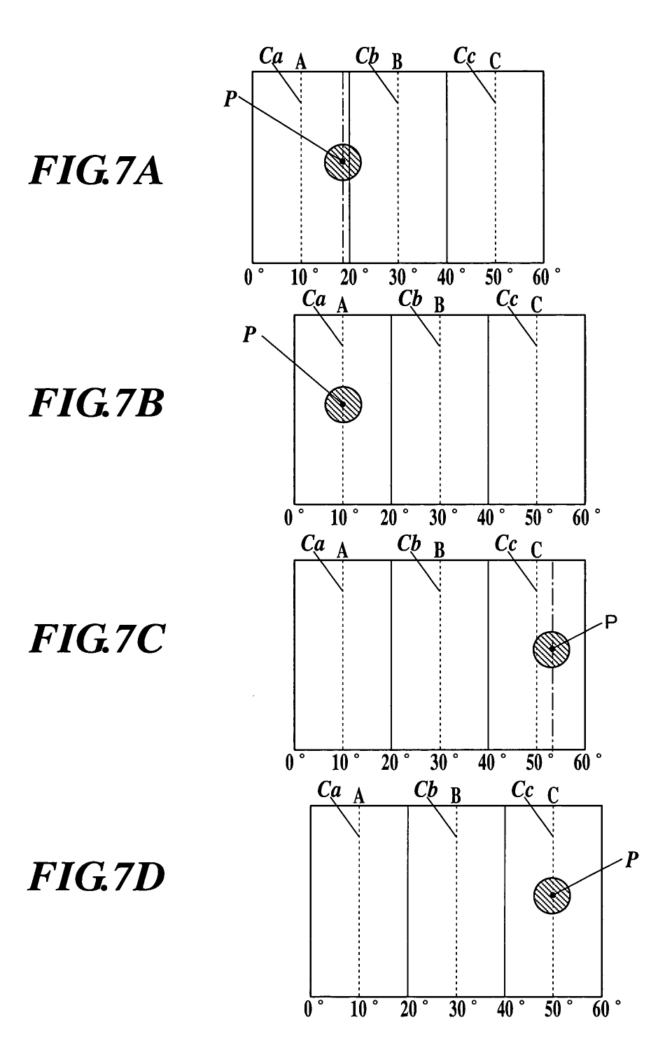

Next, a tracking imaging performance processing conducted by the CPU 61 in the monitoring mode is described with reference to FIG. 7.

The tracking imaging performance processing is conducted by execution of the imaging program 63a, the moving body detecting program 63b, the moving body position identification program 63c, the area determining program 63d, and the tracking program 63e by the CPU 61.

When a monitoring mode changing-over switch 42a provided on the operation panel 41 of the operation input unit 4 is depressed by a user, the CPU 61 sets a monitoring mode corresponding to an inputted signal (step S1). In step S2, by executing the imaging program 63a, the CPU 61 lights the near infrared ray light source 512, and irradiates the predetermined monitoring region. Next, the CPU 61 conducts imaging of the predetermined monitoring region by driving the imaging device 52, captures the first image data (step S3), and stores the captured first image data in the memory unit 62 (step S4). Further, the CPU 61 conducts imaging of the predetermined monitoring region by driving the imaging device 52, captures the second image data (step S5), and stores the captured second image data in the memory unit 62 (step S6). In step S7, by executing the moving body detecting program 63b, the CPU 61 conducts difference processing of the first image data and the second image data stored in the memory unit 62, and according to the difference image generated by the difference processing, difference in brightness of the first image data and the second image data is measured (step S8). Subsequently, the CPU 61 determines whether a difference in brightness larger than the standard value is measured (step S9), and when it is determined that a difference in brightness larger than a standard value is measured, the CPU 61 determines that a moving body is detected (step S9; Yes), and moves on to step S10. When it is not determined that a difference in brightness larger than the standard value is measured, the CPU 61 determines that a moving body is not detected (step S9; No), and returns to step S5, within replacing the second image data stored in the memory unit 62 in step S6 as first image data. The CPU 61 repeats the processing of steps S5 through S9 until it is determined that a value larger than the standard value is measured in step S9.

In step S10, by executing the moving body position identification program 63c, the CPU 61 conducts processing such as binarization, labeling, and the like to the difference image in which a moving body is detected, and further conducts feature point extracting processing to detect gravity center P of the moving body. Here, the CPU 61 identifies the gravity center P of the moving body as the position of the moving body. Further, the CPU 61 calculates x-coordinate value of the gravity center P of the moving body (step S11). Subsequently, by executing the area determining program 63d, the CPU 61 determines in which area the gravity center P as the position of the moving body is positioned (step S12). When the area in which the gravity center P of the moving body is positioned is determined, by executing the tracking program 63e, the CPU calculates a rotation angle required to overlap the center line of the area in which the gravity center P of the moving body is determined to be positioned, with the center gravity P of the moving body (step S13). Subsequently, the CPU 61 outputs an instruction signal to rotate the self-propelled cleaner 100 for the amount calculated to the motor driving unit 2, makes the self-propelled cleaner 100 (step S14) rotate, and moves on to step S15.

In step S15, the CPU 61 determines whether the monitoring mode changing-over switch 42a is depressed or not, and when it is determined that it is not depressed (step S15; No), the processing returns to step S5, within replacing the second image data stored in the memory unit 62 in step S6 as first image data. In step S15, when the CPU 61 determines that the monitoring mode changing-over switch 42a is depressed (step S15; Yes), the CPU 61 turns off the near infrared ray light source 512 (step S16), cancels the monitoring mode, and ends the processing.

Next, concerning the afore-mentioned tracking imaging performance processing, a tracking imaging performance processing after identification of the position of the moving body is described with specific example.

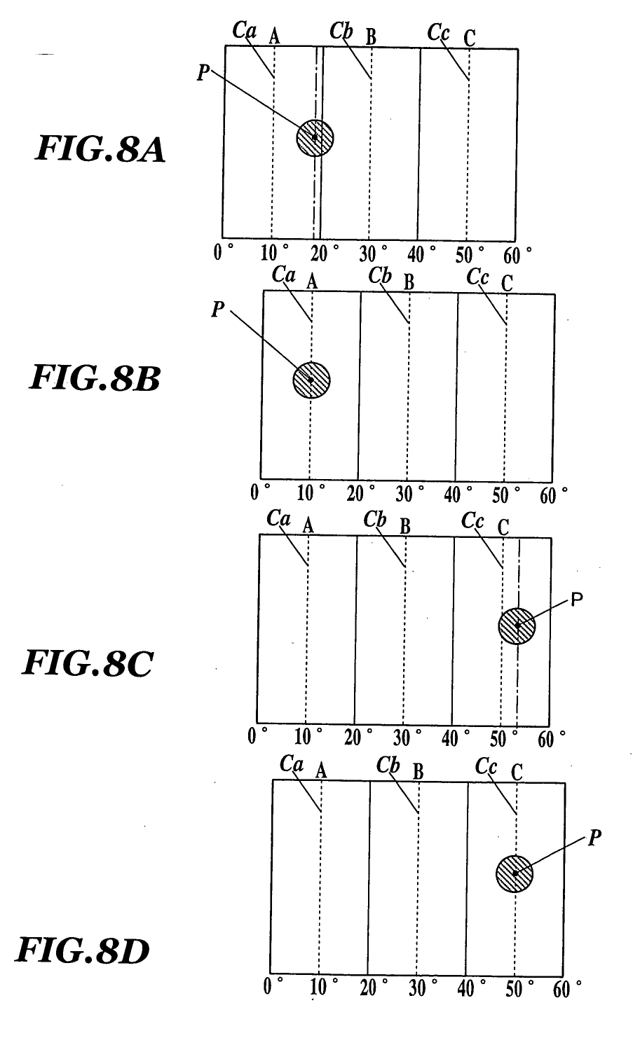

FIG. 8 is a view showing an example of image data, imaged by the imaging device 52 in the tracking imaging performance processing after identification of the position of the moving object.

As shown in FIG. 8A for example, when the CPU 61 identifies the position of the moving body by detecting the gravity center P of the moving body, it calculates the x-coordinate value of the gravity center P of the moving body. When the x-coordinate value of gravity center P as the position of the moving body is, for example when it is 18 degrees, the CPU 61 determines that the moving body is positioned in area A. Next, the CPU 61 calculates a rotation angle in which the center line Ca of area A overlaps the gravity center P of the moving body. That is, for example, since the x-coordinate value of the center line Ca of area A is 10 degrees and the x-coordinate value of the gravity center P of the moving body is 18 degrees, the CPU 61 calculates the rotation angle as 8 degrees in the right direction. Subsequently, the CPU 61 drives the motor 22 of the motor driving unit 2, and rotation drive the self-propelled cleaner 100 in the right direction for amount of 8 degrees. When the CPU 61 detects by the gyro sensor 71 that it has been rotated for 8 degrees, rotation drive is terminated. At this time, as shown in FIG. 8B, the center line Ca of area A and the gravity center P of the moving body overlap with each other.

Subsequently, for example, when the moving body moves again as shown in FIG. 8C and the CPU 61 identifies the position of the moving body by detecting the gravity center P of the moving body, it calculates an x-coordinate value of the gravity center P of the moving body. When the x-coordinate value of gravity center P as the position of the moving body is, for example when it is 53 degrees, the CPU 61 determines that the moving body is positioned in area C. Next, the CPU 61 calculates a rotation angle in which the center line Cc of area C overlaps the gravity center P of the moving body. That is, for example, since the x-coordinate value of the center line Cc of area A is 50 degrees and the x-coordinate value of the gravity center P of the moving body is 53 degrees, the CPU 61 calculates the rotation angle as 3 degrees in the right direction. Subsequently, the CPU 61 drives the motor 22 of the motor driving unit 2, and rotation drive the self-propelled cleaner 100 in the right direction for amount of 3 degrees. When the CPU 61 detects by the gyro sensor 71 that it has been rotated for 3 degrees, rotation drive is terminated. At this time, as shown in FIG. 8D, the center line Cc of area C and the gravity center P of the moving body overlap with each other.

According to the afore-described self-propelled cleaner 100 of the present invention, when a moving body is detected in the monitoring region as a result of execution of the moving body detecting program 63b by the CPU 61, position of the moving body is identified according to the gravity center P of the detected moving body, by execution of the moving body position identification program 63c. Further, an area in which the gravity center P as the position of the moving body exists is determined, as a result of execution of the area determining program 63d by the CPU 61. Subsequently, the self-propelled cleaner 100 is rotation drived so that the center line of the area (that is, one among Ca, Cb, and Cc) which was determined that gravity center P as position of the moving body is positioned, overlaps with the gravity center P of the moving body, as a result of execution of the tracking program 63e by the CPU 61. Therefore, since tracking of moving body by the monitoring device 9 is conducted more minutely compared to the conventional technique, problems such as tracking cannot be done in a timely manner, and condition of the monitoring region cannot be ascertained fully, can be decreased even in case where the moving body moves fast in the monitoring region. Thus, monitoring of the moving body can be conducted more securely and more stably.

In addition, since the imaging is conducted by irradiating near infrared ray to the monitoring region and imaging reflected light of the irradiated near infrared ray, monitoring can be conducted even in a case where brightness of the monitoring region is not enough, such as nighttime.

Further, concerning the difference image of the first image data and the second image data, an area in which difference in brightness larger than a predetermined difference in brightness is measured, is detected as the moving body. In addition, the gravity center P of the moving body, which is detected as a result of execution of the moving body detecting program 63b by the CPU 61, is identified as the position of the moving body. Therefore, detection and position identification of the moving body are conducted securely.

In addition, since the self-propelled cleaner 100 is provided with the monitoring mode, the monitoring mode can be set or cancelled as in need, and performance as self-propelled cleaner 100 or performance as monitoring device 9 can be selected for use.

Here, the present invention is not limited to the afore-mentioned embodiment, and various kinds of modification and alteration in design can be applied as far as it does not deviate the scope of the invention.

For example, the present invention has a structure in which imaging region concerning the image data obtained by the imaging device 52 is divided into three area, however, the imaging region concerning the image data may be divided into any number of area, and longitudinal direction as well as lateral direction of the image data may be divided in to a plurality of areas.

In addition, the present invention has a structure in which the motoring device 9 is provided to the self-propelled cleaner 100, however, it may also be a structure in which the monitoring device 9 is provided to other electronics device such as a television device and the like.

The present invention has a structure in which the package 1 of the self-propelled cleaner 100 provided with the imaging device 52 rotates and conducts tracking of moving body, however, it may also be a structure in which only the imaging device 52 moves.

The present invention is especially effective in a case where monitoring of a moving body that conducts back-and-forth movement in the monitoring region, however, it may also be combined with conventional techniques such as those that conduct tracking so as to adapt the center of monitoring region of the image data to the moving body, to have a structure in which an effective tracking manner can be selected among a plurality of tracking manners according to the characteristics of the moving body.

Further, it may have a structure in which a plurality of imaging devices 52 are provided to conduct continuous imaging of the moving body with another imaging device in a case where the moving body goes out of an imaging region of an imaging device, or it may also have a structure in which an imaging device to regularly image the entire monitoring region within fixed field of view, is provided in addition to the imaging device to conduct tracking of the moving body.

The present invention has a structure in which near infrared ray is irradiated to the monitoring region to conduct imaging, however, it may also be a structure in which imaging is conducted with other light sources such as visible light and the like, or a structure in which light source to conduct imaging can be selected among a plurality of light sources.

The present invention has a structure in which the irradiation device 51 and the imaging device 52 are provided on the upper surface portion of the package 1, however, the irradiation device 51 and the imaging device 52 may be provided at any place, and the irradiation device 51 may be provided at the front surface portion of the package 1 separately from the imaging device 52.

The entire disclosure of Japanese Patent Application No. Tokugan 2005-224368 filed on Aug. 2, 2005 including specification, claims, drawings and summary are incorporated herein by reference in its entirety.

What is claimed is:

1. A self-propelled cleaner provided with a monitoring device to monitor a moving body that moves in a monitoring region, the monitoring device comprising:
an infrared ray irradiating section to irradiate infrared ray to the monitoring region;
an imaging section to obtain image data by imaging a reflected light of an infrared ray irradiated from the infrared ray irradiating section;
a moving body detecting section to detect a region that has a difference in brightness larger than a predetermined difference in brightness, as the moving body, concerning a difference image of first image data and second image data obtained continuously by the imaging section;
a moving body position identification section to identify a gravity center of the moving body as a position of the moving body according to the image data obtained by the imaging section, wherein the moving body is detected by the moving body detecting section;
an area determining section to determine an area in which the moving body is positioned, according to the position of the moving body identified by the moving body position identification section, by dividing an imaging region concerning the image data obtained by the imaging section; and
a tracking section to conduct tracking of the moving body by moving the imaging section so that a predetermined center region of the area in which it is determined that the moving body is positioned overlaps with the position of the moving body identified by the moving body position identification section.

2. A monitoring device to monitor a moving body that moves in a monitoring region comprising;
an imaging section to obtain image data by imaging the monitoring region;
a moving body detecting section to detect whether the moving body exists or not, according to the image data obtained by the imaging section;
a moving body position identification section to identify a position of the moving body according to the image data obtained by the imaging section, wherein the moving body is detected by the moving body detecting section;
an area determining section to determine an area in which the moving body is positioned, according to the position of the moving body identified by the moving body position identification section, by dividing an imaging region concerning the image data obtained by the imaging section; and
a tracking section to conduct tracking of the moving body by moving the imaging section so that a predetermined center region of the area in which it is determined that the moving body is positioned overlaps with the position of the moving body identified by the moving body position identification section.

3. The monitoring device according to claim 2, further comprising an infrared ray irradiating section to irradiate infrared ray to the monitoring region, wherein the imaging section images a reflected light of an infrared ray irradiated from the infrared ray irradiating section.

4. The monitoring device according to claim 2, wherein:
the moving body detecting section detects a region in which a difference in brightness larger than a predetermined difference in brightness is measured, as the moving body, concerning a difference image of first image data and second image data imaged continuously by the imaging section; and
the moving body position identification section identifies a gravity center of the moving body as a position of the moving body detected by the moving body detecting section.

5. A self-propelled cleaner provided with the monitoring device according to claim 2.
